(19) United States
(12) Patent Application Publication
(10) Pub. No.: US 2006/0164074 A1
(43) Pub. Date: Jul. 27, 2006

(54) Magnetic sensor for determining the location of controlled magnetic leakages

(76) Inventors: Olivier Andrieu, Beynost (FR); Laurent Dufour, Meximieux (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/560,295

(22) PCT Filed: Jun. 17, 2004
(86) PCT No.: PCT/FR04/01507

§ 371 Date: Mar. 28, 2006

(30) Foreign Application Priority Data
Jun. 17, 2003 (FR) 0307277

(51) Int. Cl. G01B 7/14

(52) U.S. Cl. 324/207.13

(57) ABSTRACT

The invention relates to a magnetic sensor for determining the location of a moving object (2) along an axis of displacement (T), the sensor including:
an open magnetic circuit (3) that delimits at least one gap (8) and includes means (4) for creating a magnetic flux,
at least one first measuring cell (11) fixedly mounted in the magnetic circuit (3) and capable of measuring the value of the magnetic flux,
means for processing the output signal delivered by the measuring cell (11) in order to determine the linear location of the moving object along the displacement axis. According to the invention:
the magnetic circuit (3) also includes at least one pole piece (5) associated with means for creating a magnetic flux,
the measurement cell (11) is mounted near an extreme point of displacement so as to measure the magnetic flux delivered by the creating means (4) minus the magnetic leakage flux.

The present invention relates to the technical field of contactless magnetic sensors suitable for locating the position of a moving object along a preferably linear, axis of displacement.

The object of the invention finds a particularly advantageous application but not exclusively in the field of motor vehicles, for equipping different displacement units with linear displacement in particular, the location of which should be known and for example forming part of an automatic gear box, a suspension, a controlled clutch, a power steering, an attitude adjustment system, etc.

In the state of the art, there are many types of suitable contactless sensors for knowing the linear location of an object moving in translation. For example, U.S. Pat. No. 4,810,965 describes a magnetic sensor including a closed magnetic circuit including a U-shaped pole piece provided, between both of its free ends, with a magnet creating magnetic induction along a direction perpendicular to the surface of the pole piece. A mobile measuring cell is mounted between the branches of the pole piece in order to measure the magnetic induction value relatively to the surface of the pole piece. Such a cell thus measures the magnetic leakage induction strength occurring between both branches of the pole piece, the strength of this magnetic leakage induction varying at the surface of the pole piece along the measuring cell's axis of translation. Such a sensor also includes means for processing the output signal delivered by the measuring cell in order to determine the linear location of the moving object along the translation axis.

The sensor described by this patent requires the making of a closed magnetic circuit, which is a manufacturing constraint which increases its cost. Moreover, guiding of the measuring cell should be relatively accurate as the cell moves between two pole surfaces. Further, the mobility of the measuring cell poses problems notably with electric connection to the processing electronics.

From document DE 3 803 293, a position sensor is further known which measures the magnetic flux of a mobile magnet, at a given position located between two measuring cells. The major drawback of a such a sensor has to do with the fact hat it can only measure a limited travel of the moving object, taking into account large magnetic leakages and the low value of the magnetic flux sensed by the measuring cells.

The object of the present invention is therefore directed to finding a remedy to the drawbacks stated above, by proposing a contactless magnetic sensor suitable for determining the locations of a moving object having a large linear displacement travel, the sensor being of a simple economical design and capable of operating with a large gap.

To achieve such a goal, the magnetic sensor includes:

an open magnetic circuit which delimits at least one gap and includes means for creating a magnetic flux, mounted, displaceable by the moving object, delimiting at least one gap,

at least one first measuring cell fixedly mounted in the magnetic circuit and capable of measuring the value of the magnetic flux relatively to the displacement axis,

means for processing the output signal delivered by the measuring cell in order to determine the linear location of the moving object along the displacement axis.

According to the invention:

the magnetic circuit also includes at least one pole piece associated with means for creating a magnetic flux orientated at least perpendicularly to the surface of the pole piece, from the pole piece emerges a magnetic leakage flux, the strength of which varies at the surface of the pole piece along the axis of displacement,

the measuring cell is mounted near an extreme displacement point so as to measure the magnetic flux delivered by the creation means, minus the magnetic leakage flux.

According to a preferred embodiment, the magnetic sensor includes a second measuring cell fixedly mounted in the magnetic circuit near the other extreme point of displacement so as to measure the magnetic flux delivered by the creation means, minus the magnetic leakage flux.

Advantageously, the means for creating the magnetic flux are mounted so as to be displaceable in translation.

According to a first exemplary embodiment, the processing means for determining the location of the moving object, calculate the difference between the output signals delivered by the first and second measuring cells.

According to a second exemplary embodiment, the processing means for determining the location of the moving object, calculate the difference between the output signals delivered by the first and second measuring cells, divided by the sum of the output signal delivered by the first and second measuring cells.

According to an advantageous embodiment feature, the processing means include means for analyzing each output signal in an independent or combined way in order to establish a diagnose on the operating state of each measuring cell.

Advantageously, the means for creating the magnetic flux consist of a radially magnetized annular component, the axis of which is parallel to the axis of translation.

According to another embodiment, the means for creating the magnetic flux consist of a series of at least four magnets, the magnetization directions of which are shifted two-by-two by 90°.

According to certain applications, the open magnetic circuit includes a second pole piece positioned facing the first pole piece, delimiting a gap with the latter.

According to this alternative embodiment, the second pole piece is provided with means for creating the magnetic flux.

For example, this second pole piece is formed by a tubular component equipped with the radially magnetized annular component.

Advantageously, either one of the pole pieces has a planar profile suitable for improving the linearity of the output signal delivered by the measuring cells.

Various other features will become apparent from the description made below with reference to the appended drawings which show, as non-limiting examples, embodiments of the object of the invention.

FIG. 1 is a schematic view showing the principle of a sensor according to the invention.

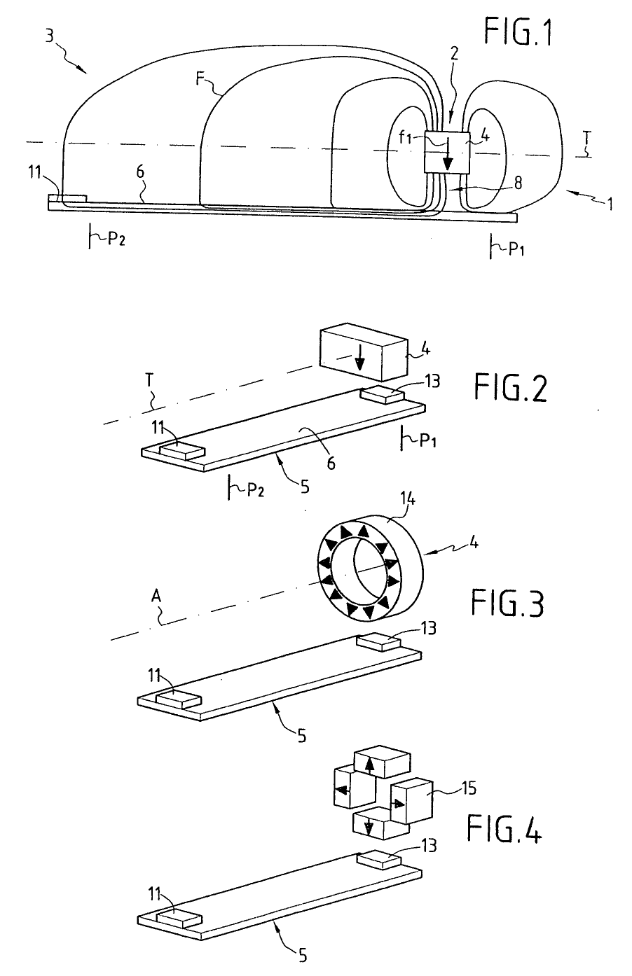

FIG. 2 is a perspective schematic view showing a preferred embodiment of the sensor according to the invention.

FIGS. 3 and 4 are perspective views showing various embodiments of the means for creating a magnetic flux.

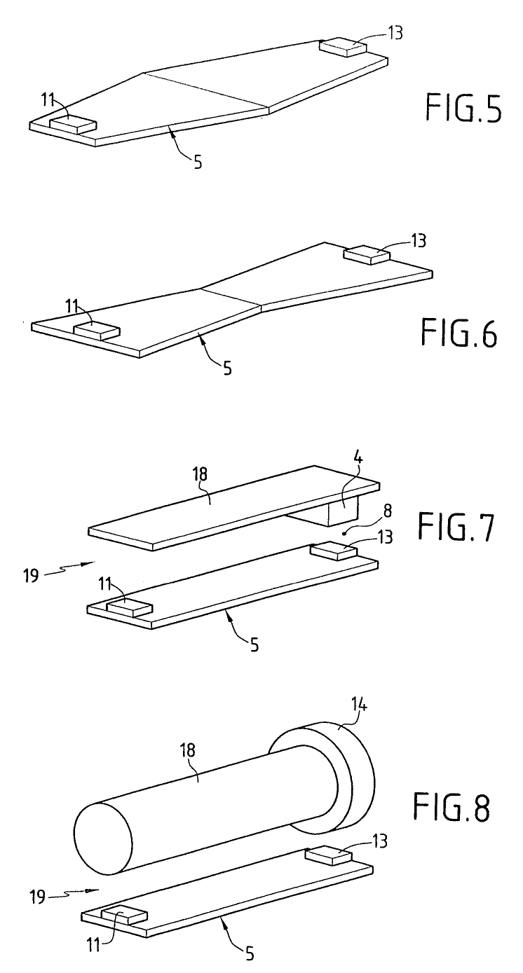

FIGS. 5 and 6 illustrate two alternative profile embodiments for pole pieces which may be applied by a sensor according to the invention.

FIGS. 7 and 8 are perspective views of two alternative embodiments of the sensor according to the invention.

As seen in FIGS. 1 and 2 more specifically, the object of the invention relates to a magnetic sensor 1 suitable for determining the location of a moving object 2 in the general sense, moving along an axis of displacement T which in the illustrated example is an axis of translation. The moving object 2 consists of any type of units having in the illustrated example, linear travel, preferably but not exclusively being part of a device equipping a motor vehicle. In the following of the description, the moving object 2 is considered as having linear travel but it is clear that the object of the invention may be applied for a moving object 2 having different displacement travel for example circular travel. Generally, the moving object 2 moves along the displacement axis T between two extreme points noted as P₁ and P₂ in the example illustrated in FIG. 1.

The sensor 1 comprises a fixed magnetic circuit 3 including means 4 for creating a magnetic flux along a direction f₁ perpendicular to the axis of translation T. The magnetic circuit 3 also includes at least one first pole piece 5 having a surface 6 extending substantially perpendicularly to the direction f₁, of the magnetic flux and parallel to the axis of translation T. The magnetic flux emerges from the pole piece 5 along a direction perpendicular to the surface 6.

According to the invention, the means 4 for creating the magnetic flux are mounted, displaceable by the moving object 2, delimiting a gap 8 with a first pole piece 5. Preferably, the means for creating the magnetic flux 4 consist of a magnet being part of or added in any suitable way to the moving object 2, the position of which is to be determined along the displacement axis T. The magnet 4 thus delivers a magnetic flux orientated perpendicularly to the surface 6 of the first pole piece 5. It should be noted that the pole piece 5 has a length at least equal to the travel to be measured of the moving object 2 determined between the extreme points P₁ and P₂. Moreover, as this will become apparent from the description which follows, the first pole piece 5 is made in a suitable material for limiting the hysteresis effect and according to suitable dimensions so as not to reach its magnetic saturation value.

According to a feature of the invention, the sensor 1 includes at least one first measuring cell 11 mounted in the magnetic circuit 3 and capable of measuring the value of the magnetic flux relatively to the first pole piece 5. Such a measuring cell 11 like a Hall effect cell for example, is capable of measuring at a fixed determined position, the variations of the value of the magnetic flux flowing in the magnetic circuit. In the example illustrated in FIG. 1, the measuring cell 11 is mounted near an extreme point P₂ of displacement. More specifically, the measuring cell 11 is mounted outside the travel of the moving object 2 and near an extreme point of displacement.

It should be understood that the cell 11 measures the magnetic flux delivered by the magnet 4 minus the magnetic leakage flux, certain field lines F of which are illustrated in FIG. 1. The cell 11 thereby measures the residual magnetic flux at one displacement end, this residual magnetic flux being equal to the total flux of the magnet 4 minus the direct magnetic leakage flux between the magnetic circuit 3 and the magnet 4. Insofar the leakage flux monotonically depends on the relative location between the magnet 4 and the cell 11, the output signal delivered by the cell 11 gives information on the location of the magnet 4 and subsequently of the moving object 2 along the axis of translation T. Of course, measurement is possible if the magnetic circuit and in particular the pole piece 5 are not saturated. The output signal delivered by the measuring cell 11 is transmitted to the signal processing means, not shown but known per se, allowing the linear location of the moving object 2 to be determined along the axis of displacement T.

According to a preferred embodiment feature, sensor 1 includes a second measuring cell 13 fixedly mounted in the magnetic circuit 3 near the other extreme point, i.e., P₁ in the example illustrated in FIG. 2. As explained above, cells 11 and 13 are placed outside the delimited travel between points P₁ and P₂. This second measuring cell 13 is also capable of measuring the magnetic flux delivered by the magnet 4 minus the magnetic leakage flux. It should be noted that in the illustrated examples, the measuring cells 11, 13 are fixed on the pole piece 5 so that each measuring cell 11, 13 is crossed by the magnetic flux emerging from the pole piece 5 according to an orientation perpendicular to its surface 6. Of course, the measuring cells 11, 13 may be placed near the extreme points P₁ and P₂ without being in direct contact with the pole piece 5.

By producing a magnetic sensor 1 including two measuring cells 11, 13, it is possible to obtain a differential measurement structure in order to improve the linearity of the output signal from the measuring cells.

According to a first alternative embodiment, it may be contemplated that the processing means for determining the location of the moving object calculate the difference between the output signals delivered by the first 11 and second 13 measuring cells.

According to another embodiment feature, it may be contemplated that the processing means for determining the location of the moving object 2 calculate the difference between the output signals delivered by the first 11 and the second 13 measuring cells, divided by the sum of the output signals delivered by the first 11 and the second 13 measuring cells. With such processing, it is possible to obtain an output signal which is not very sensitive to drifts of the signals delivered by the cells 11, 13 for example due to changes in gap or temperature.

According to an advantageous feature of the invention, the processing means include means for analyzing each output signal in an independent or combined way in order to establish a diagnose on the operating state of each measuring cell 11, 13. Thus, for example, a faulty state may be detected, for a cell which delivers a signal which is not found in a range of predefined values. Also, if the sum of the signals delivered by the cells is outside a determined interval, a faulty state is detected. In the same sense, insofar that the signals delivered by both cells are independent but symmetrical on either side of the location of the magnet 4, such a characteristic may be analyzed in order to detect the operating state of the measuring cells 11, 13.

In the example illustrated in FIGS. 1 and 2, the means for creating a magnetic flux 4 are produced via a magnet, the magnetization direction of which is perpendicular to the surface 6 of the first pole piece 5. In the case when the moving object 2 also undergoes rotation along the T axis, it may be contemplated that as illustrated in FIG. 3, the means for creating a magnetic flux 4 are produced via a radially magnetized annular component 14, the axis A of which is parallel to the axis of displacement T. In the example illustrated in FIG. 4, the means 4 for creating the the magnetic flux consist of a series of at least four magnets 15, the magnetization directions of which are shifted by 90°, two-by-two.

According to an advantageous feature more specifically illustrated in FIGS. 5 and 6, the pole piece 5 may have a suitable planar profile for improving the linearity of the output signal delivered by the measuring cells 11, 13. For example, the pole piece 5 may have a symmetrical surface formed by two conical frustra mounted head-to-tail with their large bases joined (FIG. 5) or with their small bases joined (FIG. 6).

FIG. 7 illustrates another alternative embodiment of the sensor applying a second pole piece 18 either identical or not with the first pole piece 5 allowing magnetic leakages to be limited, i.e., allowing the magnetic flux to be channeled in the magnetic circuit 3. In the example illustrated in FIG. 7, the second pole piece 18 includes a planar surface positioned facing the first pole piece 5, delimiting with the latter a gap 19 at one of its ends. The other end of this second pole piece 18 is equipped with the magnet 4 which also delimits a reduced gap 8 with the first pole piece 5.

FIG. 8 illustrates another embodiment of the second pole piece 18 made with a tubular component on which the radially magnetized annular component 14 is mounted, as illustrated in FIG. 3. This second pole piece 18 also delimits a gap 19 with the first pole piece 5.

The invention is not limited to the described and illustrated examples as various changes may be made thereto, without departing from its scope.

1. A magnetic sensor for determining the location of a moving object (2) moving along an axis of displacement (T), the sensor including:
an open magnetic circuit (3) delimiting at least one gap (8) and including means (4) for creating a magnetic flux, mounted, displaceable by the moving object (2), delimiting at least one gap (8),
at least one first measuring cell (11) fixedly mounted in the magnetic circuit (3) and capable of measuring the value of the magnetic flux relatively to the axis of displacement,
means for processing the output signal delivered by the measuring cell (11) in order to determine the linear location of the moving object along the axis of displacement, characterized in that:
the magnetic circuit (3) also includes at least one pole piece (5) associated with means for creating a magnetic flux orientated at least perpendicularly to the surface (6) of the pole piece, from the pole piece emerges a magnetic leakage flux, the strength of which varies at the surface of the pole piece along the axis of displacement (T),
the measuring cell (11) is mounted near an extreme point of displacement so as to measure the magnetic flux delivered by the creating means (4) minus the magnetic leakage flux.

2. The magnetic sensor according to claim 1, characterized in that it includes a second measuring cell (13) fixedly mounted in the magnetic circuit (3) near the other extreme point of displacement so as to measure the magnetic flux delivered by the creating means (4) minus the magnetic leakage flux.

3. The magnetic sensor according to claim 1, characterized in that the means for creating a magnetic flux (4) are mounted, displaceable in translation.

4. The magnetic sensor according to claim 2, characterized in that the processing means for determining the location of a moving object (2), calculates the difference between the output signals delivered by the first (11) and the second (13) measuring cells.

5. The magnetic sensor according to claim 2, characterized in that the processing means for determining the location of the moving object (2), calculates the difference between the output signals delivered by the first (11) and the second (13) measuring cells, divided by the sum of the output signals delivered by the first and second measuring cells.

6. The magnetic sensor according to claim 1, characterized in that the processing means include means for analyzing each output signal in an independent or combined manner in order to establish a diagnose on the operating state of each measuring cell (11, 13).

7. The magnetic sensor according to claim 1, characterized in that the means for creating a magnetic flux (4) comprises a radially magnetized annular component (14), the axis of which is parallel to the axis of translational displacement.

8. The magnetic sensor according to claim 1, characterized in that the means for creating a magnetic flux comprises a series of at least four magnets (15), the magnetization directions of which are shifted by 90°, two-by-two.

9. The magnetic sensor according to claim 1, characterized in that the open magnetic circuit (3) includes a second pole piece (18) positioned facing the first pole piece (5), delimiting a gap (19) therebetween.

10. The magnetic sensor according to claim 9, characterized in that the second pole piece (18) is provided with means for creating the magnetic flux (4).

11. The magnetic sensor according to claim 9, characterized in that the second pole piece (18) is formed with a tubular component equipped with a radially magnetized annular component (14).

12. The magnetic sensor according to claim 1, characterized in that either one of the pole pieces (5, 18) has a suitable planar profile for improving the linearity of the output signal delivered by the measuring cells (11, 13).
